(19) United States
(12) Patent Application Publication
(10) Pub. No.: US 2012/0163399 A1
(43) Pub. Date: Jun. 28, 2012

(54) TIME-MULTIPLEXED MULTI-WIRE COMMUNICATIONS SYSTEM

(75) Inventors: Feliciano Gomez Martinez, San Jose, CA (US); Joon Bae Kim, Lexington, MA (US)

(73) Assignee: Lantiq Deutschland GmbH, Neubiberg (DE)

(21) Appl. No.: 13/333,197

(22) Filed: Dec. 21, 2011

Related U.S. Application Data
(60) Provisional application No. 61/427,091, filed on Dec. 23, 2010.

(51) Int. Cl. H04L 12/43

(52) U.S. Cl. 370/458

(57) ABSTRACT

A system includes a universal transceiver and a switch coupled to the universal transceiver, wherein the switch is configured to selectively couple a terminal of the universal transceiver to one of a plurality of different physical media. The universal transceiver is configured to generate a global schedule based on at least one input received by the universal transceiver, wherein the global schedule controls the switch.

### REFERENCE TO RELATED APPLICATIONS

This application claims priority to provisional patent application Ser. No. 61/427,091, entitled, “Time-Multiplexed Multi-Wire Communications System,” filed on Dec. 23, 2010, which is hereby incorporated by reference in its entirety.

### FIELD

This application is directed to a communication system, and more particularly to a system and method of operating a single transceiver in conjunction with two or more different communication media using time-multiplexing.

### BACKGROUND

There is growing interest among telecommunication service providers to use existing home wiring (electrical wiring, phone wiring and coaxial cables) for delivery of multiple communications services, including Internet Access, PTV, VoIP, etc. Existing home wiring combines the advantages of wireless technologies (they can be used anywhere in the home and no new wires need to be installed) with the advantages of wired Ethernet (very reliable and stable connection and data rate not impacted by walls between transmitter and receiver).

Although there are multiple proprietary technologies for transmission over existing home wiring, currently there is only one internationally recognized standard for this application. The standard (with the generic name G.hn) specifies transmission over power lines, phone lines and coaxial cables.

The standard is designed in a way that requires each G.hn transceiver to be associated permanently with one specific medium. This means that if a device wants to communicate over two or more different physical media, the device needs to include two or more G.hn transceivers, one for each physical medium.

The requirement to have one transceiver per medium increases the cost of the solution and reduces its benefits to the user.

The problem is not solved today. Due to high cost, there are very few devices that support more than one physical medium at the same time. To date, one way to build a device with multiple media support is to use multiple transceivers, one for each medium.

### SUMMARY

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

In one embodiment of the invention a system comprises a universal transceiver and a switch coupled to the universal transceiver. The switch is configured to selectively couple a terminal of the universal transceiver to one of a plurality of different physical media. Further, the universal transceiver is configured to generate a global schedule based on at least one input received by the universal transceiver, wherein the global schedule controls the switch.

In another embodiment of the invention a universal transceiver comprises a global scheduler component configured to generate a global schedule based on at least one input received by the universal transceiver. The transceiver further comprises a switch configured to selectively couple a terminal of the universal transceiver to one of a plurality of different physical media based on the global schedule, and a data link layer/physical layer block configured to be adjusted based on the global schedule and provide and/or receive data to or from the terminal of the universal transceiver.

In yet another embodiment of the invention a method of interfacing in a network having multiple different physical media comprises receiving at a universal transceiver at least one input associated with the multiple different physical media. The method further comprises generating a global schedule at the universal transceiver using the received at least one input, and using the global schedule to control a time-multiplexing of the universal transceiver with the plurality of different physical media.

The following description and annexed drawings set forth in detail certain illustrative aspects and implementations of the invention. These are indicative of only a few of the various ways in which the principles of the invention may be employed.

### BRIEF DESCRIPTION OF THE DRAWINGS

FIG. 1 is a block diagram illustrating a system for performing time-multiplexing in a multi-wire communication system according to one embodiment of the invention.

FIG. 2 is a block diagram illustrating a system for performing time-multiplexing in a multi-wire communication system according to another embodiment of the invention.

FIG. 3 is a block diagram illustrating a universal transceiver with a medium scheduler component that generates medium-specific schedules based on the global schedule provided by the global scheduler according to one embodiment of the invention.

### DETAILED DESCRIPTION

One or more implementations of the present invention will now be described with reference to the attached drawings, wherein like reference numerals are used to refer to like elements throughout. The invention relates to a system and method of operating a single transceiver in conjunction with two or more different communication media using time-multiplexing.

As highlighted above, with today's state of the art, it is difficult to build a transceiver that is connected to multiple different media. One sub-optimal option involves connecting a transceiver to multiple media at the same time. When the transceiver transmits a signal, the signal is propagated through all media concurrently. In the receive path, the transceiver will receive any signal transmitted in any medium.

There are two problems with this solution that have been acknowledged by the inventors of the present invention. The first problem is there is no common standard signaling scheme that can be transmitted over different physical media. Even in standards such as ITU G.hn, which are designed to operate over multiple media, the PHY layer has slight variations in each medium. For example, the OFDM tone-spacing in G.hn for powerline is 24.41 kHz, while the tone-spacing for coaxial cable is 195.31 kHz. Sending the exact same signal over multiple media would be non-compliant with the standard. A second problem is that connecting the transceiver to all media at the same time in practice causes the multiple media to be merged into a single collision domain. This means that one device operating over coaxial cable could not transmit data at the same time as another device operating over powerlines. If both transmitted signals at the same time, both signals would collide at the point where the “universal transceiver (multi-medium device)” is connected to both media. Even if the first problem could be solved by changing the standards to achieve a common signaling scheme, the second problem would still be present.

Another option acknowledged by the inventors of the present invention is connecting the transceiver in alternate fashion to each medium, using some switching device that connects the analog front end (AFE) of the transceiver to each medium. The transceiver is never connected to two media at the same time in such a solution. There is, however, a problem with this approach: if the transceiver is connected to one type medium (e.g., the coaxial medium) at any given time, there exists the possibility that another node in another medium (e.g., the powerline domain) will attempt to send data to the universal transceiver (or sometimes referred to as a domain master or master node). Because the universal transceiver is not connected to the powerline medium at that precise moment, the data will be lost. In practice, this will require the data to be re-transmitted at a later time, thus reducing network performance.

According to one embodiment of the invention, the above problem is solved by using the approach described above, but using a special management protocol to avoid the problem of lost data, by ensuring that while a transceiver is connected to one medium, nodes connected in another medium will not attempt to transmit any data to that transceiver.

Avoiding the problem of lost data can be achieved in two implementations, each with different degrees of complexity. For example, a control message is sent periodically, wherein the control message includes a schedule of transmission opportunities for the various domains (i.e., the different physical media). In one instance the schedule dictates a time frame when a particular domain can transmit, and all other time periods no transmission can occur. In another instance the schedule dictates a time frame when a particular domain con transmit to the universal transceiver, and other time periods the transmission opportunities cannot be used to transmit to the universal controller, but may be used to transmit elsewhere.

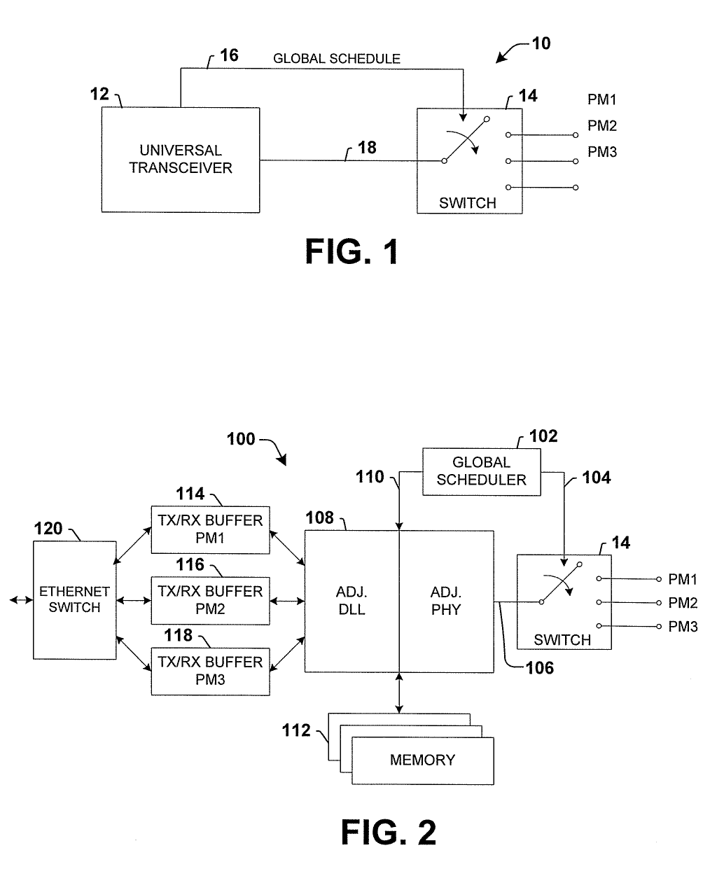

This principle can be more fully appreciated in conjunction with FIG. 1, in which a time-multiplexed multi-wire system 10 is illustrated. The system 10 includes a universal transceiver 12 operably coupled to a switch 14. Depending on the various standards, the universal transceiver 12 is also referred to as a domain master (DM) in G.hn, a network coordinator in MoCA, a central coordinator in HomePlug AV, a BSS manager in IEEE P1901, or a master node. In one embodiment the universal transceiver 12 sends a control signal 16 based on a global schedule that dictates a switching of the switch 14 to couple a terminal 18 of the universal transceiver 12 to one of a plurality of different physical media (e.g., PM1, PM2 and PM3). In one example, PM1 is powerline, PM2 is telephone wiring and PM3 is coaxial cable, however, other various different media may be employed and are contemplated as falling within the scope of the present invention. Not only does the global schedule 16 dictate what medium is coupled to the terminal 18, but the global schedule 16 also dictates a timing of the switching.

In one embodiment of the invention the universal transceiver 12 generates the global schedule based on one or more inputs. For example, such inputs may include, but are not limited to: a number of nodes in a given domain, service needs for nodes connected to each medium, and available physical layer data rate available in each medium. Therefore if a number of nodes associated with PM1 is substantially greater than a number of nodes associated with PM2, the global schedule may allocate a larger time slot to PM1 compared to PM2. Alternatively, even if the number of nodes of PM1 is substantially greater than that of PM2, if the service needs of the nodes of PM2 are greater than that of PM1, the amount of time allocated to PM2 may be increased by the universal transceiver 12. Lastly, if the physical layer data rate available for PM1 is greater than that of PM2, the global schedule may allocate more time to PM2 because of the slower data rate. In any event, the universal transceiver employs one or more such inputs in generating the global schedule.

As stated above, the “universal transceiver” is the G.hn Domain Master (DM). In one specific G.hn example, the universal transceiver 12 or domain master periodically sends a control message called a MAP (Medium Access Plan) that includes a detailed schedule of “transmission opportunities” (TXOP) in the line. Using the MAP, the universal transceiver 12 can allocate TXOP for specific uses (for example, it can specify that a TXOP can only be used by node X to send data to node Y). More generally, the universal transceiver 12 determines a global schedule, and based on the determined global schedule generates individual schedules for each domain, and communicates such individual schedules to the various nodes associated therewith.

In a first option, using G.hn as an example, the universal transceiver 12 specifies that a TXOP should remain unused (i.e., no device can transmit any data in the domain). As described in Section §8.8.2.2 in ITU-T Recommendation 6.9961-2010, for example, using SID=255 in a TXOP descriptor “specifies a TXOP or TS in which transmissions are prohibited”. Similar mechanisms exist in other technologies such as HPAV, 1901 or MoCA and may be employed, and such alternatives are contemplated as falling within the scope of the invention.

In a second option, still using G.hn as an example, the universal transceiver 12 specifies that a TXOP can be used, but never to transmit data to the universal transceiver (given that the universal transceiver will not be listening to the media). This is achieved by specifying other node's Device ID in the DID field in the TXOP descriptor. Similar mechanisms exist in other technologies such as HPAV, 1901 or MoCA and such alternatives are contemplated as falling within the scope of the invention.

While the first option above is relatively simple to implement, one potential disadvantage is that it only allows one medium to be active at a time, thus limiting overall network performance. An advantage of the second option above is that it increases overall network performance by allowing all media to be active at any given time, but it requires a more complex scheduling algorithm. Both options are permitted with the present invention.

In review of FIG. 1, one particular aspect of the invention is that a single universal transceiver is connected to two or more physical media by means of a physical medium selection switch that, at any given time, allows signals to be transmitted/received to/from one single medium. During that time, nodes associated with other physical media will not attempt to transmit to the universal transceiver due to the global schedule. One alternative here would be a programmable transceiver that can be quickly re-configured to operate in multiple standards over multiple physical media (one at a time). Examples could be MoCA over coax and HPAV over powerline.

In the system 10 of FIG. 1, the physical medium selection switch 14 is controlled by the universal transceiver 12, and the universal transceiver 12 may act as the G.hn domain master (or equivalent function in other technologies) in each of the domains, that is, a single device serves multiple domain master functionalities for these domains.

In addition, the universal transceiver 12 creates a global schedule that details in which time the universal transceiver 12 will be connected to each domain. The global schedule is created using a variety of inputs including, but not limited to, a number of nodes in a domain, the service needs for nodes connected to each medium, and the available physical-layer date rate available in each medium, etc.

Turning now to FIG. 2, a block diagram is provided illustrating various components of a universal transceiver 100 according to another embodiment of the invention. The universal transceiver 100 includes the switch 14 or may be connected to an external switch. The universal transceiver 100 further comprises a global scheduler component 102 configured to output a first control signal 104 to the switch 14 according to a global schedule 110 it constructs to control a switching state and a switching timing. In this way, a terminal 106 provides or receives data to or from one of a plurality of different physical media (PM). As highlighted above, the global schedule 110 generated by the global scheduler component 102 may, for example, be based on one or more inputs such as nodes per domain, service needs of nodes per domain, and a PHY layer data rate per domain.

The global scheduler component 102 also interfaces with a data link layer (DLL)/physical layer (PHY) block 108 that is configurable based on what physical media is connected thereto based on the global schedule. Thus the global scheduler component 102 provides the global schedule 110 to the DLL/PHY block 108, which in turn accesses a memory 112 containing a plurality of sets of state information that is used to configure either the DLL, the PHY layer, or both, based on the physical media connected thereto based on the global schedule 110. Thus the memory 112, in one embodiment, stores state information for either the DLL, the PHY layer, or both, for each physical medium. State information includes, but is not limited to frequency/phase tracking information, and hardware configuration parameters such as FFT (fast fourier transform) size, GI (guard interval) size, PSD (power spectral density) masks, etc. In the above manner, the universal transceiver 100 is configurable in accordance with the global schedule.

The universal transceiver 100 further comprises a plurality of transmit/receive (TX/RX) buffers 114, 116, 118 that are associated with the plurality of different physical media, respectively. That is, data received from physical medium #1 (PM1) is received by the switch 14 on the terminal 106, and passed through the DLL/PHY block 108 to the TX/RX buffer 114. The data is then passed from the buffer 114 to an Ethernet switch 120, for example. Likewise, the other TX/RX buffers 116 and 118 temporarily store data for transmission on a corresponding physical media or store data received on the corresponding physical media, respectively.

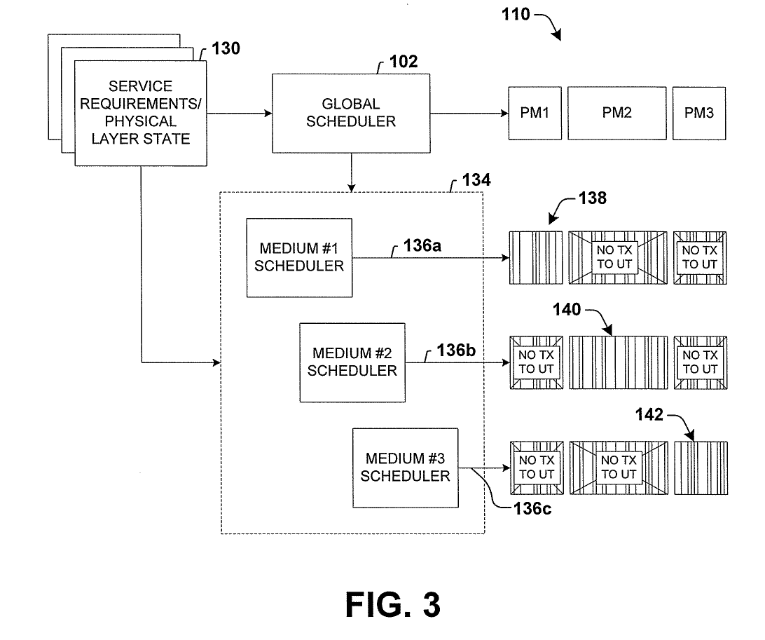

FIG. 3 is another block diagram that illustrates further details of the universal transceiver with respect to building the global schedule and then individual medium-specific schedules based on the global schedule. The global scheduler component 102 receives data such as service requirements for nodes of each physical medium and physical layer data rate information 130, and also information about the number of nodes per domain by receiving reporting information about the number of nodes and/or type of nodes per domain by receiving reporting information during an initialization time period and/or periodically via update periods. All such information is utilized in crafting a global schedule or amending the global schedule 110, for example, as shown. In this example, an amount of time allocated to PM2 is substantially greater than for PM1 and PM3 based on various input data considerations discussed above.

Once the global schedule 110 is constructed, the global schedule information is provided to an individual scheduler block 134, wherein each individual medium-specific schedule 136a-136c is constructed. Such individual schedules 136a-136c are based on information 130 where appropriate, and also individual node information for each physical medium. As shown in FIG. 3, a PM1 schedule time 138 may include differing duration time slots for various nodes associated with PM1 to transmit, and some or all nodes may be given multiple time slots within period 138 to transmit data to the universal transceiver 100. During the time period 138, PM1 is coupled to the terminal 106 in FIG. 2 through the switch 14 based on the control signal 104 dictated by the global schedule 132. Thus during that time period it is assured that neither PM2 nor PM3 can transmit to the universal transceiver 100. Also, during this time period, the DLL/PHY block 108 of FIG. 2 is configured with proper state information from the memory 112 based on the global schedule 110 to assure proper receipt of data from PM1.

Still referring to FIG. 3, the medium-specific schedule 136b is associated with a time period 140 of the global schedule 110, and includes one or more time slots for the various nodes associated with PM2 to transmit. Similarly, the global schedule 110 configures the DLL/PHY block 108 via memory 112 to receive data properly over PM2 via the switch 14. Further, during the time period 140, the global schedule 110 dictates that no data is transmitted to the universal transceiver 100 along PM1 and PM3. In like manner, the medium-specific individual schedule 136c schedules time slots for nodes of PM3 during a time 142 dictated by the global schedule 110. The global schedule 110 configures the DLL/PHY block 108 via memory 112 to receive data properly over PM3 via the switch 14. Further, during the time period 142, the global schedule 110 dictates that no data is transmitted to the universal transceiver 100 along PM1 and PM2.

As highlighted above, the universal transceiver uses the global schedule 110 to create individual schedules 136a-136c for each domain. The individual schedule in each domain satisfies the condition that, when the universal transceiver 100 is connected to one medium, nodes in the other domains cannot transmit data to the universal transceiver 100, but they may be allowed to transmit data to each other.

As shown in FIG. 3, the universal transceiver distributes the individual schedule for each domain using control messages, such as MAP messages, as described in Section §8.2 and §8.3 of ITU-T Recommendation G.9961 (or equivalent messages in other technologies). Other nodes in each one of the domains (e.g., PM1, PM2, and PM3) receive the MAP message (or equivalent message), and ensure that their transmissions are in compliance with the schedule announced in the MAP. The universal transceiver 100 controls the physical medium selection switch 14 in alignment with the global schedule 110.

An exemplary communication arrangement may employ one, two or more multicarrier apparatuses, transceivers or nodes. The exemplary communication arrangement may also employ a multicarrier controller apparatus or controller node. In one implementation, the multicarrier apparatuses/controller are Orthogonal Frequency Division Multiplexing (OFDM) apparatuses capable of implementing the herein described implementations. One or more apparatuses, transceivers or nodes may implement the embodiments described herein.

The multicarrier apparatuses may communicate through a communication channel. The communication channel may be realized as a wireless communication medium, a wireline communication medium (e.g., coaxial cable, twisted pair of copper wires, power line wiring, optical fiber, etc.), or combinations thereof. Accordingly, the multicarrier apparatuses, may include structure and functionality that enable signal communication over such medium. Such structure and functionality may include one or more antennas, integrated wireline interfaces, and the like. Depending on the implementation, the multicarrier apparatuses may communicate with one another directly (peer-to-peer mode) or the multicarrier apparatuses may communicate via the controller apparatus.

In one implementation, the exemplary communication arrangement may be a home network and the multicarrier controller apparatus may be an access point of the home network. For example, in the implementation the controller apparatus may be a residential gateway that distributes broadband services to the multicarrier apparatuses. The multicarrier apparatuses may be associated with digital content destinations in the home, but may also be associated with digital content sources, such as digital video recorders (DVR), computers providing streaming video, televisions, entertainment centers, and the like.

Furthermore, the multicarrier apparatuses may be enabled to communicate using packet-based technology (e.g., ITU G.hn, HomePNA, HomePlug® AV and Multimedia over Coax Alliance (MoCA)) and xDSL technology. Such xDSL technology may include Asymmetric Digital Subscriber Line (ADSL), ADSL2, ADSL2+, Very high speed DSL (VDSL), VDSL2, G.Lite, and High bit rate Digital Subscriber Line (HDSL). In addition, the multicarrier apparatuses may be enabled to communicate using IEEE 802.11 and IEEE 802.16 (WiMAX) wireless technologies.

Signals exchanged between the multicarrier apparatuses may include multicarrier symbols that each include a plurality of tones or sub-channels. Each of the tones within a multicarrier symbol may have data bits modulated thereon that are intended for delivery from one of the multicarrier apparatuses to another.

An exemplary transceiver apparatus that may be used as a transmitting and receiving apparatus in a multicarrier arrangement or system is described in the following. The multicarrier apparatuses may be implemented in the same or similar manner as the exemplary transceiver apparatus.

The transceiver apparatus may include a transmitter that incorporates a number of different elements. For example, the transmitter may include an encoder, a modulator, a filter, an interface and a controller. As used herein, the term “controller” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components.

The encoder may be capable of receiving data that is for communication to a receiving device coupled to the transceiver apparatus via a wireless or wireline medium. More specifically, the encoder may be capable of translating incoming data bit streams into in-phase and quadrature components for each of the plurality of tones. The encoder may be arranged to output a number of symbol sequences that are equal to the number of tones available to the system. The modulator may be capable of receiving symbol sequences to produce a modulated signal in the form of a discrete multi-tone signal. The modulator may pass the modulated signal to the filter to undergo various filtering and then the filtered signal may be passed to the interface for communication over the medium to a receiving device.

The transceiver apparatus may also include a receiver that is capable of receiving modulated multi-tone signals communicated over the medium from a transmitting device. The receiver may include an interface, a filter, a demodulator, a decoder and a controller. Alternatively, the transceiver apparatus may implement a single controller, instead of the illustrated controllers. Signals received by the receiver may be passed to the filter via the interface. After received signals undergo filtering by way of the filter, the filtered signals may be demodulated by the demodulator. The demodulated signals may be passed to and processed by the decoder. The decoder produces data bit streams for consumption by a computing device, or the like. Effectively, the demodulator and the decoder perform the opposite functions of the modulator and the encoder, respectively.

Exemplary implementations discussed herein may have various components collocated; however, it is to be appreciated that the various components of the arrangement may be located at distant portions of a distributed network, such as a communications network and/or the Internet, or within a dedicated secure, unsecured and/or encrypted arrangement. Thus, it should be appreciated that the components of the arrangements may be combined into one or more apparatuses, such as a modem, or collocated on a particular node of a distributed network, such as a telecommunications network. Moreover, it should be understood that the components of the described arrangements may be arranged at any location within a distributed network without affecting the operation of the arrangements. For example, the various components can be located in a Central Office modem (CO, ATU-C, VTU-O), a Customer Premises modem (CPE, ATU-R, VTU-R), an xDSL management device, or some combination thereof. Similarly, one or more functional portions of the arrangement may be distributed between a modem and an associated computing device.

The above-described arrangements, apparatuses and methods may be implemented in a software module, a software and/or hardware testing module, a telecommunications test device, a DSL modem, an ADSL modem, an xDSL modem, a VDSL modem, a linecard, a G.hn transceiver, a MOCA transceiver, a Homeplug transceiver, a powerline modem, a wired or wireless modem, test equipment, a multicarrier transceiver, a wired and/or wireless wide/local area network system, a satellite communication system, network-based communication systems, such as an IP, Ethernet or ATM system, a modem equipped with diagnostic capabilities, or the like, or on a separate programmed general purpose computer having a communications device or in conjunction with any of the following communications protocols: CDSL, ADSL2, ADSL2+, VDSL1, VDSL2, HDSL, DSL Lite, IDSL, RADSL, SDSL, UDSL, MOCA, G.hn, Homeplug or the like.

Additionally, the arrangements, procedures and protocols of the described implementations may be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable device, or the like. In general, any apparatus capable of implementing a state machine that is in turn capable of implementing the methodology described and illustrated herein may be used to implement the various communication methods, protocols and techniques according to the implementations.

Furthermore, the disclosed procedures may be readily implemented in software using object or object-oriented software development environments that provide portable source code that can be used on a variety of computer or workstation platforms. Alternatively, the disclosed arrangements may be implemented partially or fully in hardware using standard logic circuits or VLSI design. The communication arrangements, procedures and protocols described and illustrated herein may be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed procedures may be readily implemented in software that can be stored on a computer-readable storage medium, executed on programmed general-purpose computer with the cooperation of a controller and memory, a special purpose computer, a microprocessor, or the like. In these instances, the arrangements and procedures of the described implementations may be implemented as program embedded on personal computer such as an applet, JAVA® or CGI script, as a resource residing on a server or computer workstation, as a routine embedded in a dedicated communication arrangement or arrangement component, or the like. The arrangements may also be implemented by physically incorporating the arrangements and/or procedures into a software and/or hardware system, such as the hardware and software systems of a test/modeling device.

The implementations herein are described in terms of exemplary embodiments. However, it should be appreciated that individual aspects of the implantations may be separately claimed and one or more of the features of the various embodiments may be combined.

Although the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A system, comprising:
a universal transceiver; and
a switch coupled to the universal transceiver, and configured to selectively couple a terminal of the universal transceiver to one of a plurality of different physical media,
wherein the universal transceiver is configured to generate a global schedule based on at least one input received by the universal transceiver, wherein the global schedule controls the switch.

2. The system of claim 1, wherein the universal transceiver is further configured to generate a control signal based on the global schedule, and wherein the control signal dictates a switching state of the switch.

3. The system of claim 2, wherein the control signal based on the global schedule further defines a timing of the switching state of the switch.

4. The system of claim 1, wherein the global schedule dictates a timing in which the universal transceiver is connected to the plurality of different physical media.

5. The system of claim 1, wherein the at least one input comprises a number of nodes associated with each of the plurality of different physical media, service needs for nodes connected to each of the plurality of different physical media, or physical layer data rate available in each of the plurality of different physical media, or a combination thereof.

6. The system of claim 1, wherein the global schedule controls the switch to dictate a time multiplexing schedule of coupling the terminal of the universal transceiver to each of the plurality of different physical media.

7. The system of claim 1, wherein the universal transceiver is further configured to generate individual domain schedules for each of the plurality of different physical media.

8. The system of claim 7, wherein each individual domain schedule satisfies a condition that when the terminal of the universal transceiver is coupled to one of the plurality of different physical media via the switch, all nodes associated with the other of the plurality of different physical media can not transmit data to the universal transceiver.

9. The system of claim 8, wherein each individual domain schedule further comprises an individual time schedule for each node associated therewith, thereby allocating one or more time slots with the individual domain schedule for each node associated therewith for transmission of data to the universal transceiver.

10. The system of claim 8, wherein the universal transceiver is configured to distribute each individual domain schedule to nodes associated with each of the plurality of different physical media.

11. A universal transceiver, comprising:
a global scheduler component configured to generate a global schedule based on at least one input received by the universal transceiver;
a switch configured to selectively coupled a terminal of the universal transceiver to one of a plurality of different physical media based on the global schedule; and
a data link layer/physical layer block configured to be adjusted based on the global schedule and provide or receive data to or from the terminal of the universal transceiver, respectively.

12. The universal transceiver of claim 11, further comprising a memory configured to store sets of state information associated with each of the different physical media, wherein the data link layer/physical layer block accesses a set of state information associated with one of the plurality of different physical media based on the global schedule.

13. The universal transceiver of claim 12, wherein one of a data link layer component or a physical layer component, or both, of the data link layer/physical layer block are uniquely configured using the set of state information accessed from the memory based on the global schedule.

14. The universal transceiver of claim 11, wherein the at least one input comprises a number of nodes associated with each of the plurality of different physical media, service needs for nodes connected to each of the plurality of different physical media, or physical layer data rate available in each of the plurality of different physical media, or a combination thereof.

15. The universal transceiver of claim 11, further comprising a plurality of transmit/receive buffers, wherein each of the plurality of transmit/receive buffers is uniquely associated and configured to store data for one of the plurality of different physical media, respectively, wherein the plurality of transmit/receive buffers are configured to interface with the data link layer/physical layer block for transmission and receipt of data through the switch.

16. The universal transceiver of claim 11, further comprising a plurality of medium-specific scheduler components configured to receive the global schedule and generate medium-specific schedules for each of the plurality of different physical media.

17. A method of interfacing in a network having multiple different physical media, comprising:
receiving at a universal transceiver at least one input associated with the multiple different physical media;
generating a global schedule at the universal transceiver using the received at least one input; and
using the global schedule to control a time-multiplexing of the universal transceiver with the plurality of different physical media.

18. The method of claim 17, wherein the at least one input comprises a number of nodes associated with each of the plurality of different physical media, service needs for nodes connected to each of the plurality of different physical media, or physical layer data rate available in each of the plurality of different physical media, or a combination thereof.

19. The method of claim 17, further comprising:
generating individual domain schedules for each of the multiple different physical media based on the global schedule; and
communicating the individual domain schedules to nodes associated with the plurality of different physical media.

20. The method of claim 19, wherein each individual domain schedule further comprises an individual time schedule for each node associated therewith, thereby allocating one or more time slots with the individual domain schedule for each node associated therewith for transmission of data to the universal transceiver.
